(19) United States
(12) Patent Application Publication
(10) Pub. No.: US 2025/0094863 A1
(43) Pub. Date: Mar. 20, 2025

(54) EFFICIENT OPTIMIZATION OF MACHINE LEARNING PERFORMANCE

(71) Applicant: Microsoft Technology Licensing, LLC, Redmond, WA (US)

(72) Inventors: Agrin Aram HILMKIL, London (GB); Shantanu GUPTA, Pittsburgh, PA (US); Cheng ZHANG, Cambridge (GB); Colleen TYLER, Redmond, WA (US); Marife DEFANTE, Woodinville, WA (US); Lisa Lynne PARKS, Seattle, WA (US)

(21) Appl. No.: 18/542,517

(22) Filed: Dec. 15, 2023

Related U.S. Application Data
(60) Provisional application No. 63/584,475, filed on Sep. 21, 2023.
(60) Provisional application No. 63/584,101, filed on Sep. 20, 2023.

(51) Int. Cl. G06N 20/00

(52) U.S. Cl. CPC G06N 20/00

(57) ABSTRACT

In certain examples, a zero-shot model selection mechanism is provided. N synthetic validation sets are generated (with synthetic ground truth) that are overall representative of a given task (where N is one or greater). M candidate models (or algorithms more generally) are determined that are appropriate to the given task. In a validation stage, each of the M models is applied to each of the N synthetic validation sets, and the model output is scored relative to the corresponding synthetic ground truth. This, in turn, allows a best-performing model of the M models to be determined for each of the N synthetic datasets. Having determined the best-performing candidate model for each of the N synthetic datasets, an “algorithm selector” is trained to predict which of the M candidate algorithms will perform best on a given dataset.

### CROSS-REFERENCE TO RELATED APPLICATION

This application claims priority to U.S. Provisional Patent Application No. 63/584,101, entitled “DETERMINING AND PERFORMING OPTIMAL ACTIONS ON A PHYSICAL SYSTEM,” filed on Sep. 20, 2023, and U.S. Provisional Patent Application No. 63/584,475, entitled “EFFICIENT OPTIMIZATION OF MACHINE LEARNING PERFORMANCE,” filed on Sep. 21, 2023, the disclosures of which are incorporated herein by reference in their entireties.

The present disclosure pertains to methods and systems for optimizing performance of machine learning (ML)-based processing in a resource-efficient manner.

### BACKGROUND

In the field of ML, validation and model selection are two important concepts relating to performance testing/validation and optimization. Validation refers generally to a process of partitioning a set of labelled data into a training set and a validation set. A labelled datapoint refers to an input associated with a corresponding groundtruth label. The training set is used to train an ML model, and the validation set is used to test performance for the trained model by comparing outputs of the trained model generated on the validation set with the corresponding ground truth. One example form of validation is a conventional cross-validation strategy that involves multiple rounds of training/validation with different partitioning of the labelled dataset. In each round, the model is trained and validated on different training and validation sets. Validations results are useful in detecting issues such as overfitting, and can provide a more reliable estimate of overall model performance.

A validation approach can be used more generally for model selection. Model selection applies when multiple ML models are suitable candidates for a different task. For example, two candidate models might have a common architecture, but with different parameters/weights arising from training on different training sets. Alternatively, two candidate models may have materially different architectures. An aim in this context is to select a best-performing ML model for a given task from a set of candidate ML models. When labelled data representative of the task and hand is available, a validation approach may be used for model selection. This involves running each candidate model on the labelled data (used as a validation set in this context), assessing the model's performance with respect to ground truth, and selecting the model that performs best with respect to ground truth.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

In certain example embodiments described herein, a zero-shot model selection mechanism is provided. N synthetic validation sets are generated (with synthetic ground truth) that are overall representative of a given task (where N is one or greater). M candidate models (or algorithms more generally) are determined that are appropriate to the given task. In a validation stage, each of the M models is applied to each of the N synthetic validation sets, and the model output is scored relative to the corresponding synthetic ground truth. This, in turn, allows a best-performing model of the M models to be determined for each of the N synthetic datasets. Having determined the best-performing candidate model for each of the N synthetic datasets, an “algorithm selector” (itself, an ML model) is then trained in the following manner. Each of the N synthetic datasets is used as a training input and the algorithm selector is trained to predict, given a dataset as input, which of the M candidate models (or other algorithms) will perform best, with an indication of the best performing model from the validation stage used as ground truth in this stage.

### BRIEF DESCRIPTION OF FIGURES

Particular embodiments will now be described, by way of example only, with reference to schematic figures contained within the body of the description, which include:

FIG. 1 shows a block diagram of a causal method predictor.

FIG. 2 shows a block diagram of a causal method selector.

FIG. 3 shows a block diagram of a causal discovery method and its output.

FIG. 4 shows a block diagram of self-attention encoder method.

FIG. 5 shows certain results achieved on an example dataset by various methods.

FIG. 6 shows a block diagram of a method for generating synthetic data.

FIG. 7 shows example datasets used to train a causal method predictor.

FIG. 8 shows a flow chart of a method for pre-training a feature extractor.

FIG. 9 shows a set of scores for comparing causal method performance.

FIG. 10 shows a flow chart of a method for scoring candidate algorithms.

FIG. 11 shows a flow chart for causal method selection.

FIG. 12 shows a flow chart of a method to score causal methods.

FIG. 13 shows a flow chart of a method of fine-tuning a pre-trained feature extractor.

FIG. 14 shows a flow chart of a method for generating a target label for a dataset for training a classification head.

FIG. 15 shows a flow chart for a causal method selection process.

FIG. 16 shows a set of scores for comparing causal method performance.

FIG. 17 shows a set of scores for comparing causal method performance a real-world dataset and on a semi-synthetic dataset.

FIG. 18 schematically shows a non-limiting example of a computing system.

### DETAILED DESCRIPTION

There are various issues with convention model selection via a validation strategy with respect to ground truth. Such model selection methods may be characterized as ‘supervised’ in the sense that labelled validation data representative of a desired task is required to assess relative model performance. Therefore, conventional approaches become infeasible in situations where it is not feasible to collect the required validation data representative of the task at hand. In some practical contexts, it may be challenging or impossible to collect the required labelled data, as this often requires manual annotation. The complexity of validation increases with the complexity of the model outputs, as this has a consequent impact on the complexity of the required ground truth. This issue may be characterized as one of lack of flexibility. Moreover, validation requires significant computing resources to apply multiple candidate models to a validation set, and perform validation with respect to ground truth.

It is recognized herein that synthetic data may be used to address the flexibility issue. Synthetic data can be generated using one or more data synthesis models, based on an appropriate set of assumptions that characterise a desired task. To obtain real-world labelled data, manual annotation effort is generally required, which may be invisible or impossible in some contexts. However, with synthetic data, ground truth is inherent to the data synthesis process. For example, groundtruth corresponding to synthetic datapoints can be extracted or derived from the set of assumptions used to generate those synthetic data points. With this approach, a “self-supervised” validation mechanism may be constructed with respect to synthetic ground truth.

However, there are additional technical challenges posed by synthetic data. Synthesising appropriate data often requires significant computational resources, particularly if the data is complex. This computing resource cost increase with the amount of synthetic data required to perform validation reliably. In some context, it may not be sufficient to synthesise a signed validation dataset, as this may not be sufficiently representative of a given task (particularly if the task is complex). For example, it may not be possible to definitely characterize a task in terms of a single set of assumptions. This issue can be addressed by generating multiple synthetic validation sets, e.g. with different set of assumptions. However, this significantly increases the amount of computing resources required to synthesise the requisite data. In addition, the validation processing itself required significant computational resources, which scales with the complexity of each candidate model. With N synthetic validation sets and M candidate models, N data synthesis processes need to be performed and N*M validation processes also need to be performed.

The described embodiments address the additional technical issues set out above via a zero-shot model selection mechanism. N synthetic validation sets are generated (with synthetic ground truth) that are overall representative of a given task. M candidate models (or algorithms more generally) are determined that are appropriate to the given task. For example, a relatively ‘streamlined’ set of candidate models/algorithms may be selected from a larger pool of models/algorithms based on assumptions that are also used to synthesise the validation datasets. Each of the M models is applied to each of the N synthetic validation sets (in series, or in parallel, or in a combination of series and parallel processing), and the model output is scored relative to the corresponding (synthetic) ground truth. This, in turn, allows a best-performing model of the M models to be determined for each of the N synthetic datasets. This processing amounts to a validation stage performed on synthetic validation data. In this context, validation is used herein to mean scoring or otherwise evaluating a method on a dataset with respect to groundtruth.

Having determined the best-performing candidate model for each of the N synthetic datasets, an “algorithm selector” (itself, an ML model) is then trained in the following manner. Each of the N synthetic datasets is uses as a training input and the algorithm selector is trained to predict, given a dataset as input, which of the M candidate models (or other algorithms) will perform best. In the case that the candidate algorithm are themselves ML models, the term “model selection model” may be used. In other words, the validation sets from the validation stage are now used as training inputs in a subsequent model selection training stage. The results obtained in the validation stage provide ground truth for the model selection training stage. For each of the D validation sets, the best-performing model is known from the validation stage. Hence, treating that dataset as a training example in the model selection training, a ground truth label may be constructed, which indicates the best performing candidate model of the M candidate models. For example, this may be a “one-hot” vector that simply identifies the best performing candidate model. The ‘model selection model’ can be architected to predict a distribution over the M candidate models (or other selection output indicating a predicted best-performing candidate algorithm), which in tuns mean it can be trained to match its output to the corresponding ground truth label for each of the D datasets (e.g. based on a cross-entropy loss function applied to the model output and the model selection training label).

The process of generating N synthetic data sets and running the candidate models N*M times in the validation stage may require significant computational resources. The model selection training may also require significant computational resources. However, these computationally expensive processes need only be performed once. Once the model selection model has been trained, it is relatively efficient to apply this trained model to a new dataset at inference. For example, if the model selection model is implemented with a neural network architecture, its execution time is essentially constant (determined by its size and architecture). Once trained, the model selection model can be applied to datasets which it did not encounter during training. Importantly, this model can be applied to a real dataset exhibiting reasonably similar characteristics to the synthetic datasets uses to train the model. Hence, in a real-world setting, model selection can now be performed in a zero-shot manner, without any required for labelled real data.

To further improve efficiency, an additional pre-training stage may be introduced. In the pre-training stage, a larger number of synthetic datasets may be generated based on respective assumptions. A first model is then trained on a ‘pre-training task’ of predicting, given a dataset, one or more assumptions used to generate the training set (which is, again, a self-supervised task). Features learned in the pre-training task, may then be integrated into the method selection model. The model selection training then becomes a “fine-tuning phase” leveraging the features learned in the pre-training phase. In practice, this can significantly reduce the number of synthetic data sets (N) that are required in the model selection training stage. This, in turn, significantly reduces the amount of validation processing that is required in the validation stage to generate the groundtruth for the model selection training phase.

Herein, the term “synthetic features” refers to features extracted from a synthetic dataset, and the term “real features” refers to features extracted from a real dataset.

Herein, the term “pre-training synthetic dataset” refers to a synthetic dataset used for training a property prediction model, and the term “fine-tuning synthetic dataset” refers to a synthetic dataset used in model selection training.

With the addition of pre-training, the overall process may be summarized in the following stages:
1) Generating synthetic datasets, with one or more known properties (e.g., the properties could be assumption(s), or derived from assumption(s), used to generate the synthetic data;
2) Pre-training a first predictor to predict the known property or properties from each synthetic dataset (this does not require any manual labelling). It is feasible to generate a large number of training sets for stage 2, e.g., 10s or 100s of thousands;
3) Running several algorithms/candidate models on each synthetic dataset to obtain a result and a performance score (the candidates may, in some cases, be selected based on the properties, so as to only consume resources evaluating suitable algorithms)—this provides training data for stage 4) below; and
4) Training/fine-tuning a second predictor (algorithm selector) to predict the best-performing algorithm for a given data set, using the training data generated in 3). By incorporating the features learned in (2), the amount of training data that needs to be generated in 3) is significantly reduced, e.g. to the order of a hundred datasets or so.
5) Runtime/inference: applying the second predictor to a real dataset, to predict the best-performing algorithm/model for that dataset, and apply (only) that algorithm/model to the dataset. This yields a significant computations resource saving, as it is not necessary to run all of the (potentially expensive) candidate algorithms/models to identify the best one. Moreover, groundtruth is not required to select the best candidate.

Alternatively, stage 3) may be performed with real-data that has been labelled, or with a combination of labelled real data or synthetic data. This approach is feasible in contexts where it is feasible to generate validation groundtruth for real data. In implementations where the pre-training of stage 2) is used, this would reduce the amount of labelled real data needed in stage 3). In that case, pre-training could still be performed on synthetic data, a combination of real and synthetic data, or even real data alone, if a sufficient quantity of real pre-training data with known properties is available.

A distinction is drawn between first groundtruth used for validation/model performance assessment in stage 3) (also referred to as validation ground truth or performance assessment groundtruth), and second ground truth used in stage 4) to train the model selector (also referred to as model selection ground truth).

Relative performance may be indicated in a “one-hot” fashion by the model selection ground truth (e.g. assigning 1 to the best performing algorithm, and 0 to all others). The output of the algorithm selection model may be score-based (e.g., probabilistic, where the score for a given algorithm is interpreted as a probability of that algorithm being the best performing algorithm). A one-hot vector indicating a best performing model is one example of model selection groundtruth. Such a vector may be used to train a model selector.

Other forms of groundtruth may also be used (such as a groundtruth raking of the candidate methods). Other examples of model selection groundtruth include a vector of scores etc. Such a vectors may be used to train a model selector.

One application of this model selection approach is causal inference. Causal inference refers to a broad class of methods that identify truly causal relationships exhibited in data (as opposed to mere correlations). In this context, the M models/algorithms may take the form of different candidate causal inference models/algorithms. A ‘causal method selection’ model may be trained using the above approach, on synthetic datasets exhibiting causal relationships. The described approach is highly suitable to causal method selection, because (1) in practice, it is challenging or impossible to obtain real data with ground truth that can be used for validation and (2) causal inference methods (and therefore validation between such methods) often requires significant computational resources.

Whilst the following description focuses on casual method selection, the approach summarized above can be applied in any context where it is feasible to generate synthetic data for model selection training, and is particularly suitable selecting between candidate algorithms/models that are themselves expensive to run. For example, in computer vision, the described approach may be performed using synthetic image or sensor data, in order to rank performance of candidate computer vision models, and use those results to train a model selector. There may be particular benefits when processing high-resolution image/video data, or other large quantities of sensor data, using resource-intensive computer vision models. Another context is cybersecurity, where a model selector may be trained on synthetic cybersecurity datasets, and used e.g., to select a cybersecurity detection model predicted to have best performance for a given dataset. Other example applications include audio processing, processing of other forms of sensor data (e.g., collected in a manufacturing or engineering context). The description below pertaining to casual method selection applied equally to candidate model selection in other contexts, with the benefits set out above.

Causal inference is a fundamental problem with wide ranging real-world applications in fields such as manufacturing, engineering and medicine based on manufacturing data, engineering data and medical data respectively. Causal inference involves estimating a treatment effect of actions on a system (such as interventions or decisions affecting the system). This is particularly important for real-world decision makers, not only to measuring the effect of actions, but also to pick the best action that is the most effective.

For example, in the manufacturing industry, causal inference can help quantitatively identify the impact of different factors that affect product quality, production efficiency, and machinery performance in manufacturing processes. By understanding causal relationships between these factors, manufacturers can optimize their processes, reduce waste, and improve overall efficiency. As another example, in the field of engineering, causal inference can be used for root cause analysis and identify underlying causes of faults and malfunctions in machines or electronic systems such as vehicles or unmanned drones (e.g. aircraft systems. By analyzing data from sensors, maintenance records, and incident reports, causal inference methods can help determine which factors are responsible for observed issues and guide targeted maintenance and repair actions. In genome-wide association studies (GWAS), causal inference may be used, for example, to associate between genetic variants and a trait or disease, accounting for potential confounding factors, which in turn may allow therapeutic treatments to be developed or refined.

Methods for causal discovery or inference often rely on assumptions regarding the process generating the dataset. This means that it's important to select methods with assumptions compatible with each particular problem. While it may be possible in some cases, it requires in-depth knowledge of not only the particular problem, but also of machine learning and causal methods. In most realistic cases however, there's not a single reliable method for determining whether certain assumptions are fulfilled. Furthermore, even if the underlying assumptions are met, there may be many compatible methods. In order to allow an agent, either a person or an AI system such as an LLM, to effectively perform causal tasks, an efficient way of selecting the most suitable causal method for the given task is needed. This will then allow professionals in various fields to apply causal inference and discovery.

In some embodiments, at least one the candidate causal models may take the form of a “causal foundation model”. Causal foundation models are described in U.S. Provisional Patent Application No. 63/584,101, filed on 20 Sep. 2023, which is incorporated herein by reference in its entirety. Foundation models such as language foundation models (e.g., large language models, such as Generative Pre-Trained models) and image foundation models (e.g., DALL-E) have been built. A causal foundational model refers to general-purpose machine learning system for causal analysis, in which a single model trained on a large amount of labelled and/or unlabeled data from different domains (e.g. manufacturing, aerospace, medical, manufacturing etc.) can be adapted to other applications of causal inference applied to other domains, including domains not explicitly encountered in training. In other words, a single machine model is built that, once trained, can be directly used in any domain for any problem that can be characterized as “estimating effects of certain actions from data”. It can be instantly used in manufacturing industry, scientific discovery, medical research, aerospace industry etc. with no or little adjustment. A causal foundational model may be trained in the following operations: receiving a first training dataset specific to a first domain, the first training dataset comprising a first covariate matrix and a first treatment vector, the first training dataset obtained by selectively performing first treatment actions on at least one first physical system; receiving a second training dataset specific to a second domain, the second training dataset comprising a second covariate matrix and a second treatment vector, the second dataset obtained by selectively performing second treatment actions on at least one second physical system; training using the first training dataset and the second training dataset a causal inference model based on a training loss that quantifies error between each treatment vector and a corresponding forward mode output computed by the causal inference model, resulting in a trained causal inference model; computing a rebalancing weight vector using the trained causal inference model applied to a third dataset specific to a third domain, the third dataset comprising a third covariate matrix, a third treatment vector and a third outcome vector, the third dataset obtained by selectively performing third treatment actions on a third physical system.

Examples include finding which actions can improve industrial manufacturing processes to improve yield, finding the minimal amount of pesticides in agriculture that optimizes for the production of a certain crop or for allocating and understanding offerings provided to customers and partners in sales and marketing organizations.

The causal inference literature offers many methods to a decision-maker for answering causal questions from their dataset. For example, causal discovery from observational data has been studied under a variety of assumptions (Squires and Uhler, 2022). Similarly, a plethora of methods are available for average treatment effect (ATE) estimation like inverse propensity weighting estimators, double ML, etc. However, in practice, a user interested in causal discovery (or inference) must decide which of these methods to use for their dataset. This problem is called causal method selection: deciding which method to choose for a given causal task and dataset. Increasingly, large language models (LLM) are being deployed as interfaces for interacting with datasets using natural language queries. Recent work has shown that LLMs can be used to make the appropriate API calls based on natural language user queries (Schick et al., 2023; Patil et al., 2023).

Many of the standard supervised model selection approaches cannot be applied because, usually, a similar validation objective that can be used on the held-out validation set is not available.

Causal inference has numerous real-world applications. Causal inference may interface with the real-world in term of both its inputs and its outputs/effects. For example, multiple candidate actions may be evaluated via causal inference, in order to select an action (or subset of actions) of highest estimated effectiveness, and perform the selected action on a physical system(s) resulting in a tangible, real-world outcome. Input may take the form of measurable physical quantities such as energy, material properties, processing, usage of memory/storage resources in a computer system, therapeutic effect etc. Such quantities may, for example, be measured directly using a sensor system or estimated from measurements of another physical quantity or quantities.

For example, different energy management actions may be evaluated in a manufacturing or engineering context, or more generally in respect of some energy-consuming system, to estimate their effectiveness in terms of energy saving, as a way to reduce energy consumption of the energy-consuming system. A similar approach may be used to evaluate effectiveness of an action on a resource-consuming physical system with respect to any measurable resource.

A ‘treatment’ refers to an action performed on a physical system. Testing may be performed on a number of ‘units’ to estimate effectiveness of a given treatment, where a unit refers to a physical system in a configuration that is characterized by one or more measurable quantities (referred to as ‘covariates’). Different units may be different physical systems, or the same physical system but in different configurations characterized by different (sets of) covariates. Treatment effectiveness is evaluated in terms of a measured ‘outcome’ (such as resource consumption. Outcomes are measured in respect of units where treatment is varied across the units. For example, in one a ‘binary’ treatment set up, a first subset of units (the ‘treatment group’) receives a given treatment, whilst a second subset of units (the ‘control group’) receives no treatment, and outcomes are measured for both). More generally, units may be separated into any number of test groups, with treatment varied between the test groups.

Various causal inference methods are available. For example, for causal discovery, there may be a large set of available algorithms to choose from. Existing model selection techniques like validation cannot be used due to a lack of ground-truth labels. In the described embodiments, supervised learning is used for causal method selection: datasets are generated from a large number of synthetic causal models (both linear and nonlinear) and the various methods are scored on that dataset using the ground-truth causal model. A deep neural network is then trained to directly predict the highest-scoring method for the input dataset. This allows the network to learn implicit properties of the dataset that make it suitable for a particular method. At inference time, the network can be used in a zero-shot fashion to decide which method to run without requiring too much input and prior knowledge about the dataset from the user. The strategy is evaluated on synthetic and real-world data and show that it generalizes beyond the training distribution.

For causal discovery, a user must choose from a large set of available algorithms. Existing model selection techniques like validation cannot be used due to a lack of ground-truth labels. Semi supervised learning is used for causal method selection.

In the described embodiments, a deep-learning based approach is used to directly predict the best causal algorithm for a given input dataset by framing it as a supervised learning task. A large number of synthetic datasets are generated from linear and nonlinear causal models, and score six causal discovery methods for each dataset using the ground-truth graph. A neural network is trained to predict the highest scoring method for the synthetic datasets. This allows the network to learn implicit (and difficult to specify) properties of the dataset that make it suitable for a particular method. At inference time, the trained model can be used to select the best method in a zero-shot fashion without requiring any prior knowledge about the dataset from the user. The method has been shown to generalize beyond the training distribution by evaluating it on various synthetic and real-world causal discovery benchmarks. This method is envisaged to be used to integrate causal discovery and inference to large language models, or copilots, to allow them to accurately perform automatic causal discovery and inference.

Compared to other model selection algorithms, the disclosed method is zero-shot, meaning it can very quickly predict the best causal method for a given task/dataset. It does not require running multiple algorithms for each dataset.

Compared to model selection algorithms for supervised learning, an important technical challenge in the causal inference setting is that it is difficult to specify a validation objective to select the best method since in real applications one never has access to the true causal relationships. Instead, causal selection methods often have to rely on heuristics like sparsity in order to select from the outputs of various methods.

The present method in contrast, starts with synthetic datasets, leverages the fact that since their underlying generating process is available, the performance of any causal method can be scored accurately, and then a model to predict which method will perform the best can be trained.

Given an input dataset, the goal is to select the best causal discovery method, using a fast and assumption-free selection. Unlike traditional ML, there is no simple validation strategy available. It is hard to know which assumptions hold in the dataset. Even with known assumptions, multiple methods are available.

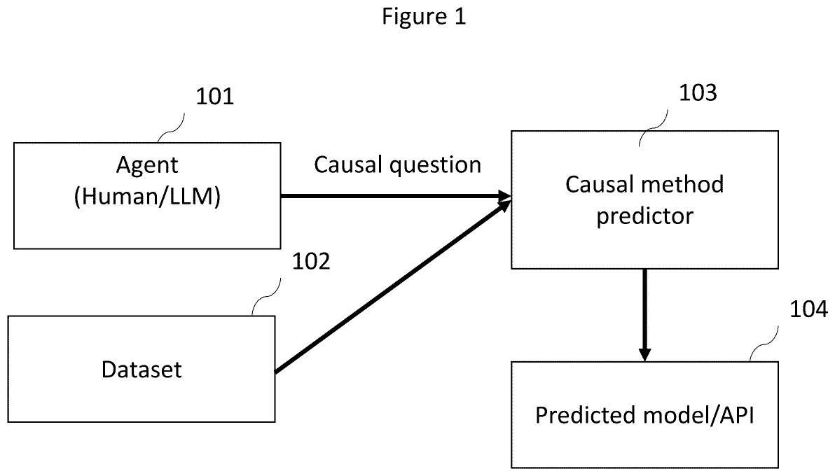

FIG. 1 shows an agent 101, referring a causal question about dataset 102 to the causal method predictor 103. Based on the dataset 102, and the causal question, the causal method predictor 103 outputs the best causal method 104. Using this selection the user can easily select the best method for their causal inference task.

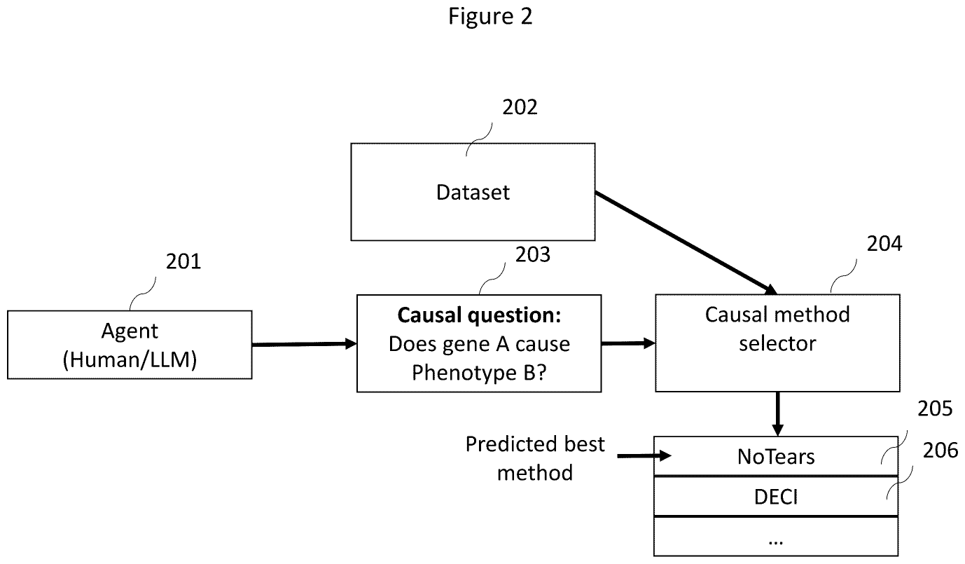

FIG. 2 shows agent 201 referring the causal question: “Does Gene A cause Phenotype B?” 203 about dataset 202 to the causal method selector 204. The causal method selector 204 ranks various methods for answering the question, and outputs the best causal method, i.e. “NoTears” 205 for the task. The method “DECI” 206 is the second best method for the causal task.

This problem is treated as a (semi) supervised classification task. A large number of datasets are generated from synthetic causal models. Generating method selection labels is expensive. Thus, first a model is trained to predict the dataset's assumptions. This pre-trained encoder is then fine tuned for method selection. The assumptions/properties used in pre-training are also a type of labels, but require fewer computing resources to produce. The semi-supervised approach matches the supervised performance with only 2000 labelled datasets. The zero-shot causal method allows method selection directly from a dataset.

The key challenge in this work is to select the best method for a causal inference task given an input dataset. Causal method selection is exemplified in two tasks: causal discovery and average treatment effect (ATE) estimation. For both tasks, a set of candidate methods is available amongst which a selection is made.

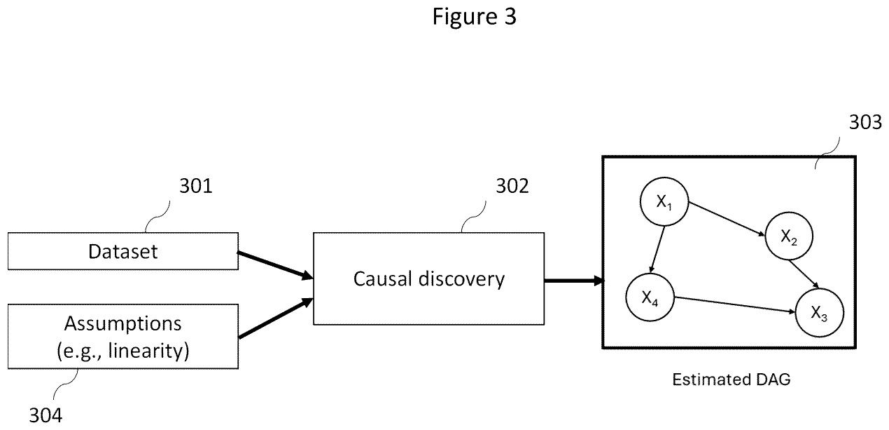

In causal discovery, the goal is to discover the underlying causal directed acyclic graph (DAG) for the input dataset. FIG. 3 shows a causal discovery method 302 which takes as input dataset 301, and assumptions 304 about the dataset, to output an estimated causal DAG 303 for the dataset 301.

Each dataset is represented by X∈R^{N×D}, where N is the number of samples and D is the number of variables (real-valued data is assumed but the proposed method can easily be generalized to discrete and mixed datasets). Throughout, it is assumed that the N samples are generated i.i.d. (independent and identically distributed) from some structural causal model (SCM) over the D variables.

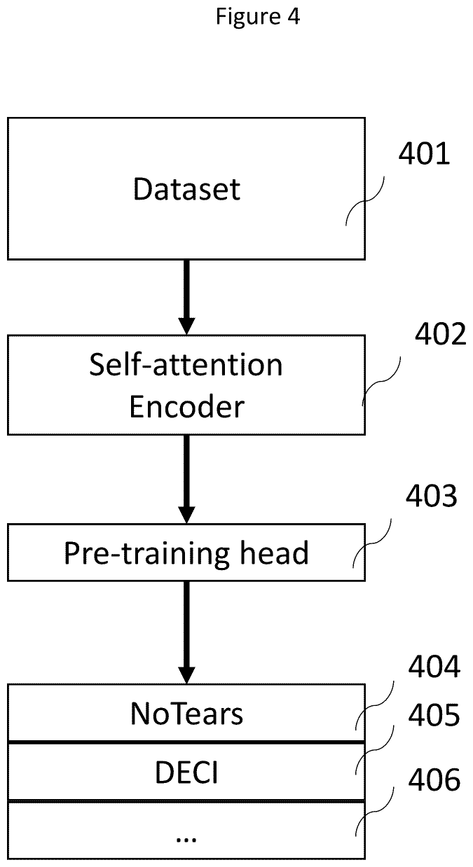

The dataset properties and assumptions may be predicted in a pre-training task performed by a pre-training head. FIG. 4 shows such a task constructed as a classification task, where the pre-training head has a classification architecture. FIG. 4 shows a self-attention encoder 402, which takes as input dataset 401, and provides an output to the pre-training head 403. The pre-training head classifies the dataset according to its estimated properties and/or assumptions e.g. Linear Gaussian 404, Linear Non-gaussian 405, or Non-linear 406.

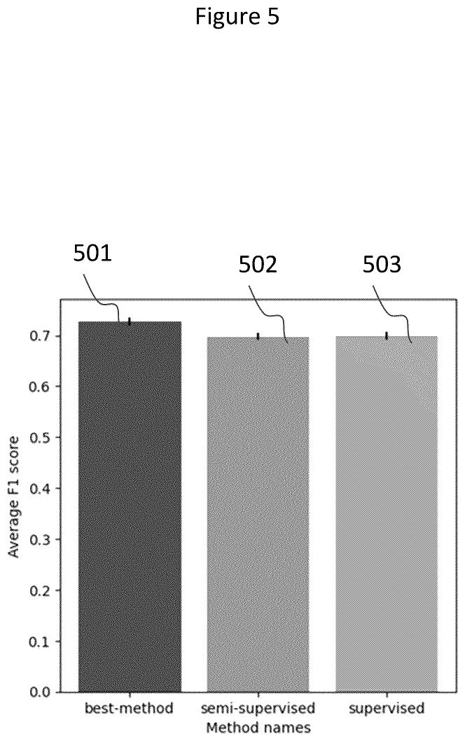

The F1-score between the binary adjacency matrices of the true DAG and the estimated DAG is used to evaluate the chosen causal method. FIG. 5 shows the F1 score achieved on an example dataset by the best causal method selected 501, a semi-supervised method 502, and a fully supervised method 503. In the fully supervised method 503, the known assumptions of the dataset are used to select a causal method. In the semi-supervised method 502, the predicted assumptions of the dataset (e.g. as predicted by a self-attention encoder) are used to select a causal method. For the best causal method 501, dataset assumptions (e.g. as predicted by a self-attention encoder) are fed to a trained classification head which predicts the best causal method.

The method is more general: can also be used for ATE estimation. The goal is to estimate the ATE of a given treatment node T on a given outcome node Y. The case where T is binary is considered. In this case, the ATE is τ= [symbol] [Y|do(T=1)]− [symbol] [Y|do(T=0)]. The squared error between the true ATE and the estimated ATE(τ−τ)² is used to score each ATE estimation method. The best method is the one with the lowest score.

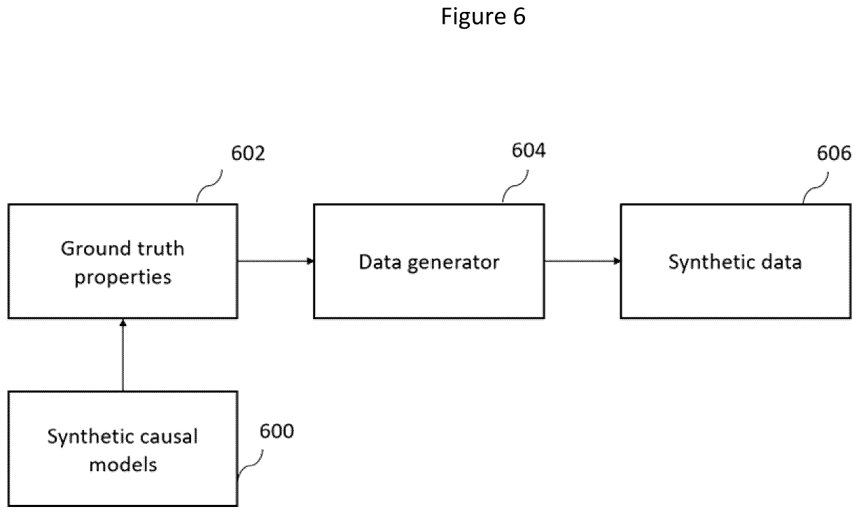

FIG. 6 shows steps for generating synthetic data 606 from synthetic causal models 600. A data generator 604 uses the ground truth properties 602 from synthetic causal models 600 (both linear and non-linear) to generate synthetic data 106. Different dataset and graph sizes are used.

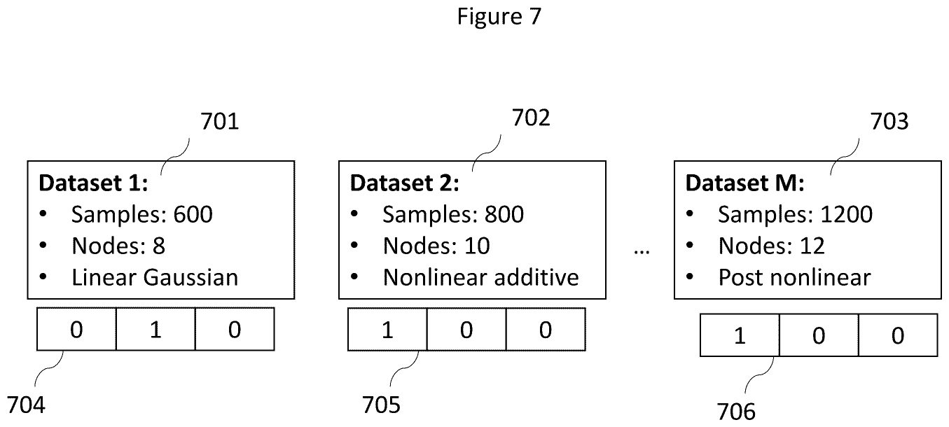

A diverse set of SCMs: linear, additive nonlinear, post nonlinear, etc models are used. The training set can have ˜20000 datasets. FIG. 7 shows example datasets 701, 702 and 703. Dataset 701 has 600 samples, 8 nodes and follows a linear gaussian model. Dataset 702 has 800 samples, 10 nodes, and follows a non-linear additive model. Dataset 703 has 1200 samples, 12 nodes, and follows post-nonlinear model. A ground truth label may be constructed, which indicates the best performing candidate model of the total number of candidate models. For example, this may be a “one-hot” vector that simply identifies the best performing candidate model. For dataset 701, the ground truth label is the one-hot vector (0, 1, 0), which indicates that the second method, out of three candidate methods is the best performing model on dataset 701. For dataset 702, the ground truth label is the one-hot vector (1, 0, 0), which indicates that the first method, out of three candidate methods is the best performing model on dataset 702. For dataset 703, the ground truth label is the “one-hot” vector (1, 0, 0), which indicates that the first method, out of three candidate methods is the best performing model on dataset 703.

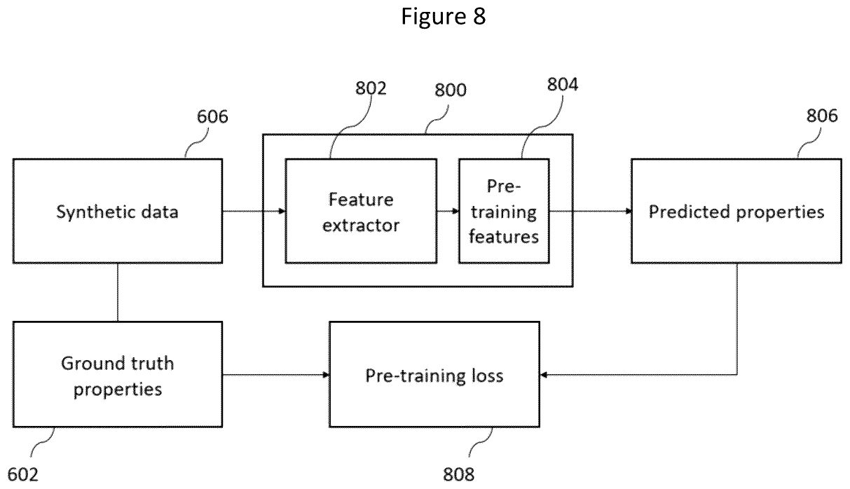

In FIG. 8, synthetic data 606 is used to pre-train a deep neural network 800. During pre-training, a feature extractor 802, of the deep neural network 800, extracts pre-training features 804 from the synthetic data 606. The deep neural network 800 uses the pre-training features 804 to predict properties 806 of the synthetic data set 606. The deep neural network 800 can compute the pre-training loss 808 by comparing the predicted properties 806 with the ground truth properties 602 of the synthetic data 606.

Various causal discovery methods are ran on these synthetic datasets. Different methods can have very different scores across various data generating regimes. Methods are evaluated on a diverse set of synthetic datasets.

In causal discovery, the goal is to discover the underlying causal DAG (or equivalence class thereof) for the input dataset. The methods that work with observational data are considered, causal sufficiency is assumed.

To further motivate the problem, the performance of six causal discovery algorithms on datasets sampled from various synthetic linear and nonlinear structural causal models (SCM), is compared. The score of an oracle that selects the highest scoring method for each dataset is displayed on a plot. The candidate methods considered are: DirectLiNGAM (Shimizu et al., 2011), NOTEARS-linear (Zheng et al., 2018), NOTEARS-MLP (Zheng et al., 2020), DAG-GNN (Yu et al.,2019), GraNDAG (Lachapelle et al., 2019), and DECI (Geffner et al., 2022). Table 1 provides a description of the six different causal discovery algorithms evaluated.

TABLE 1
Description of causal discovery methods.

| Method Name | Description |
|---|---|
| DirectLiNGAM (2011) | Linear non-Gaussian data |
| NoTears-linear (2018) | Gradient-based linear method |
| NoTears-MLP (2020) | Gradient-based nonlinear method |
| GraNDAG (2020) | Gradient-based nonlinear method |
| DAG-GNN (2019) | Uses graph neural networks |
| DECI (2022) | By Causica: flow-based model, nonlinear |

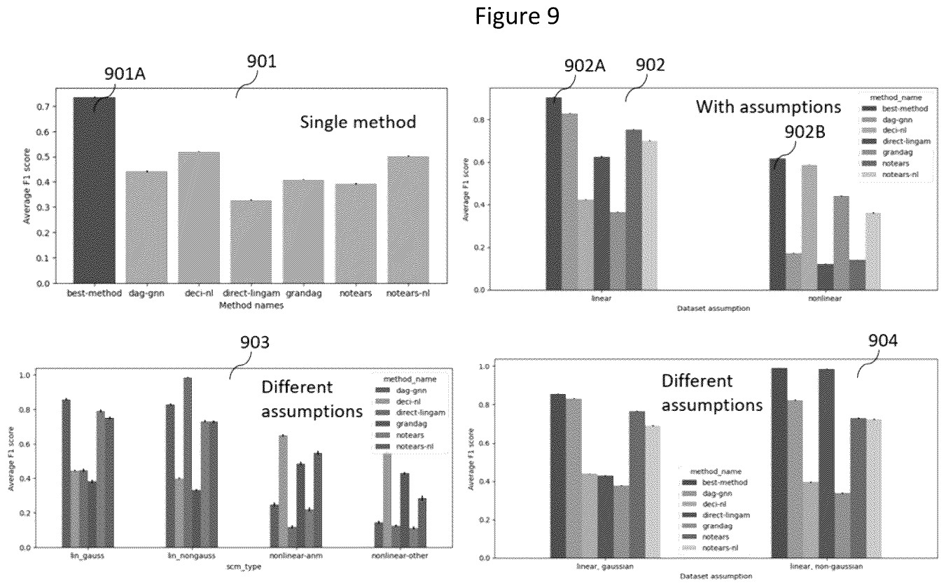

FIG. 9 plot 901 shows the F1-score between the binary adjacency matrices of the true DAG and the estimated DAG for the six methods investigated and the best method. The best method 901A is the one with the highest score (around 0.75). Firstly, it is observed that that no single method works well, i.e., there is a significant gap between the average score of the oracle (around 0.75) and any single of the six methods.

Next, the methods across different SCM types are evaluated. FIG. 9 plot 902 shows the F1-scores for the oracle and the six methods under linear and non-linear assumptions. The score of the oracle 902A under a linear assumption is around 0.9, and the score of the oracle 902B under a non-linear assumption is around 0.7. FIG. 9 plot 904 shows the F1-scores for the oracle and the six methods under linear gaussian and linear non-gaussian assumptions. It can be seen that different methods work well under different assumptions in plots 902 and 904, substantially closing the gap with the oracle, when compared to the gap in plot 901. Plot 903 shows the performance of the six methods under linear gaussian, linear non-gaussian, non linear asymptotical numerical method (anm), and other non-linear assumptions. From plot 903, it can be seen that further slicing down the assumptions reveals more patterns, when compared to plots 902 and 904.

An important challenge in the causal inference setting is that, unlike supervised learning, validation cannot be used since access to the ground-truth SCM is not available. One strategy for causal method selection would be to select the method based on the assumptions that hold in the dataset: however, it might be difficult for a user to explicitly elicit such assumptions. And even for a given set of assumptions, multiple methods can be applicable. Moreover, in practice, it is possible for a simpler method to outperform a complicated one due to fewer tuning parameters or a limited dataset size.

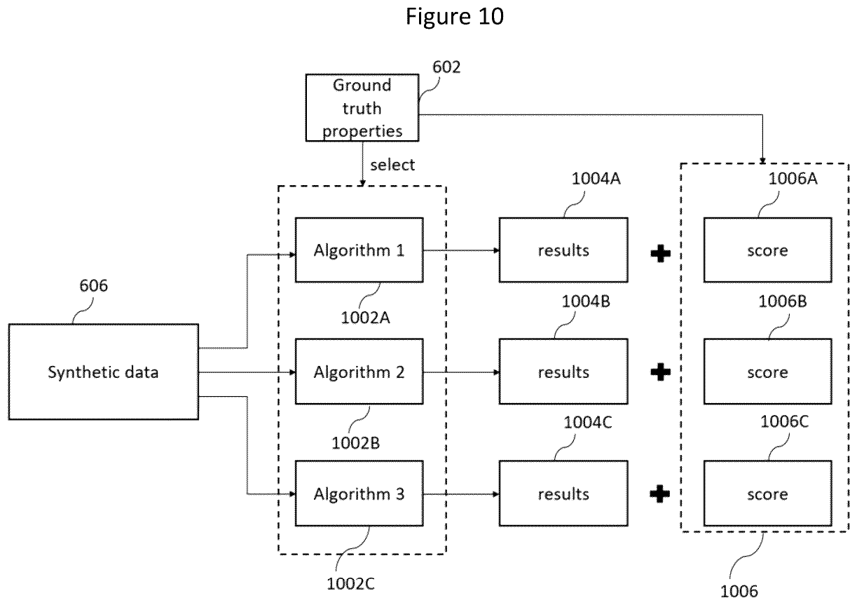

FIG. 10 shows the use of ground truth properties to score the results of candidate algorithms. In FIG. 10, candidate algorithms 1002A, 1002B and 1002C are run on every synthetic dataset 606 to obtain the results 1004A, 1004B and 1004C respectively. The ground truth properties 602 are used to score the results 1004A, 1004B and 1004C. The causal method selection is framed as a semi supervised classification task. The candidate algorithms may be for inferring causal relationships in the data. Since the ground-truth causal graph is known, the output of each method can be scored. Based on the ground truth properties 602, the results 1004A, 1004B and 1004C are given the scores 1006A, 1006B, 1006C respectively.

In this work, causal method selection is framed as a supervised classification task. Datasets are generated from a large number of synthetic SCMs (both linear and nonlinear). For every dataset, the candidate methods are ran and scored using the ground-truth SCM (which is known since it is synthetic). The target label is the method with the best score. There is one prediction made per dataset.

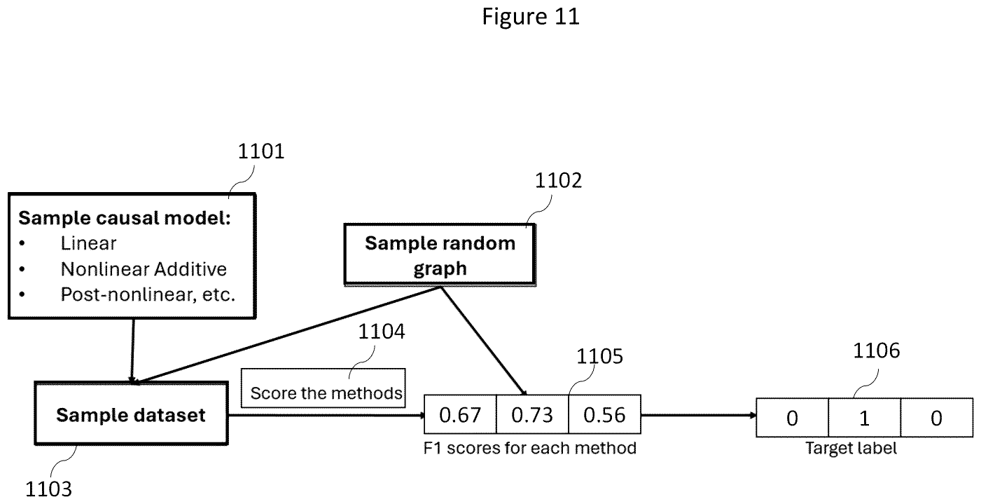

FIG. 11 shows a causal method selection process. In step 1101, a synthetic data generating process is sampled from a large number of synthetic SCMs. In step 1103, a dataset is sampled from the random graph 1102 of the sampled synthetic data generating process. The candidate causal models are ran on the dataset in step 1104 to obtain estimated DAGs predicted by each method. The F1 scores 1105 for each method are obtained by comparing the binary adjacency matrices of the true DAG 1102 and the estimated DAG obtained by running the method. The target label 1106 is a “one-hot” vector, with a “1” for the method with the best score, i.e., the second method in this example, giving a target label “(0, 1, 0)”.

A deep neural network is trained to take the entire dataset as input and predict the best method. A network architecture similar to the one in Lorch et al. (2022) is used. This allows the network to learn implicit dataset properties (e.g., the under-lying data assumptions like linearity) to predict which method is best for that dataset. At inference time, this network can be used in a zero-shot manner to directly predict the best method for an input dataset: this also does not require that each of the candidate methods be ran at inference time. Importantly, the selection strategy does not require the user to explicitly provide any prior knowledge of their dataset. Generating the labels is computationally expensive (because it requires running each method for every dataset). Therefore, a semi-supervised approach is also tested: a model is trained to predict the SCM assumptions, then the pre-trained encoder is finetuned to predict the best method.

At inference time, the dataset is input to the neural network and the predicted method is selected. Zero-shot inference directly predicts the best method for a dataset.

The present architecture is built based on the architecture from Lorch et al. (2022). For the encoder, each input instance is a dataset X∈R^{N×D}. An AVICI-style encoder (Lorch et al., 2022, Sec. 3.2.1), with alternating self-attention layers across the N and D axes, is then used. This allows the network to aggregate information across the samples and the nodes. After L such alternating self-attention layers, the dimensionality of the output is (N,D,K). A max-pooling is applied across the N and D axes, resulting in a K-dimensional embedding. This output is permutation-invariant across the N and D axes: it is desirable that the prediction of the best method be invariant to the order of the samples (since they are assumed to be i.i.d.) and the nodes. The decoder is a feedforward network with an M-dimensional output representing the logits for selecting amongst the M methods.

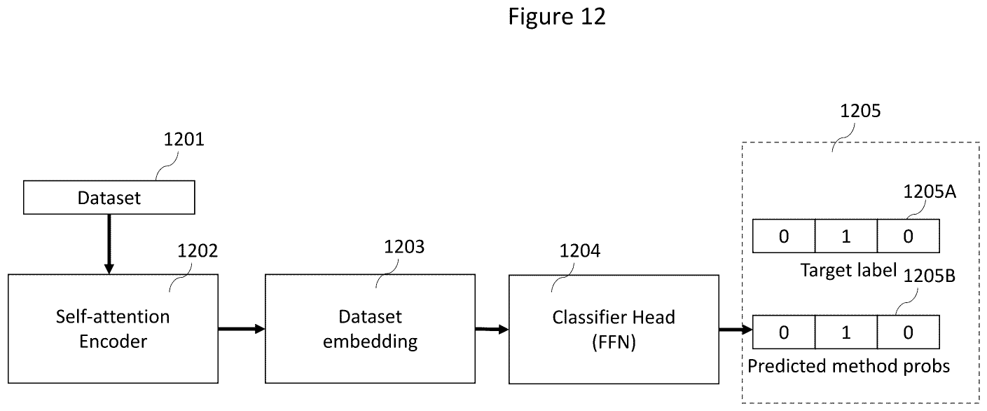

FIG. 12 shows a self-attention encoder 1202 applied to dataset 1201. Dataset embeddings 1203, which are features of the dataset, are extracted and are provided to the classifier head 1204. A classifier head 1204 predicts a probability score for each causal method. For example, for dataset 1201, the classifier head 1204 predicts a probability of 0.2 for the first method, a probability of 0.6 for the second method, and a probability of 0.2 for the third method. Thus, the predicted best causal method for dataset 1201 is the second method. When the classifier head is trained, a cross-entropy loss is computed between the predicted probabilities 1205B and the target label 1205A for the dataset.

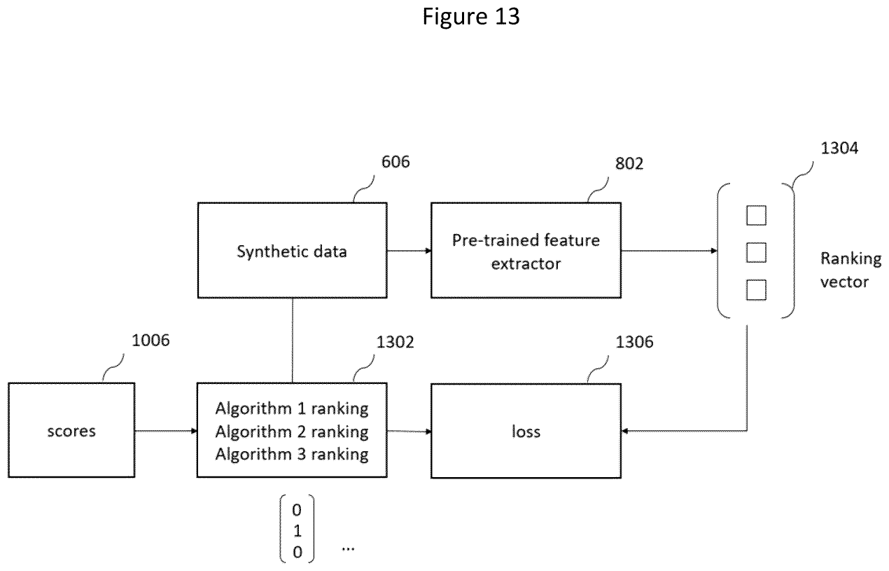

In FIG. 13, the pretrained feature extractor 802 is applied to synthetic data to obtain ranking vector 1304. The loss 1306 for fine-tuning is computed by comparing the ranking vector 1304 to the algorithm ranking 1302 obtained based on the scores 1006. The loss 1306 allows the pre-trained feature extractor to be fine-tuned to predict the best algorithm for the dataset.

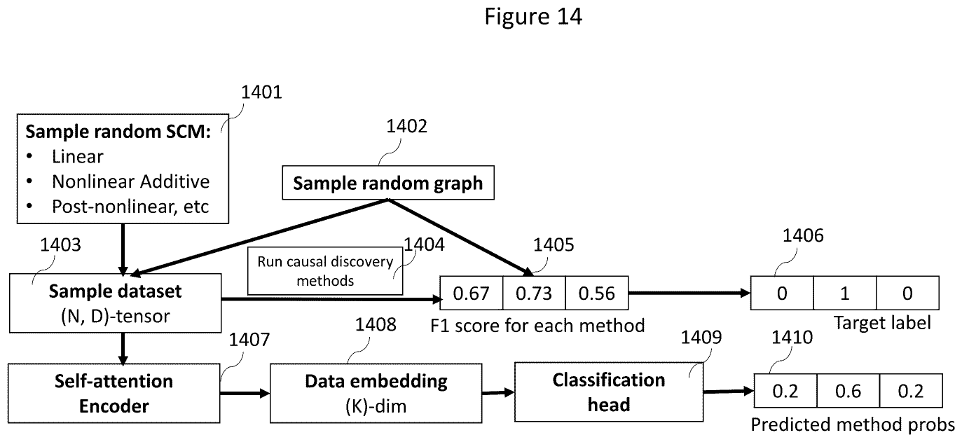

FIG. 14 shows how a target label for a dataset is generated and how it is used to train a classification head. In step 1401, a synthetic data generating process is sampled from a large number of synthetic SCMs. In step 1403, a dataset is sampled from the random graph 1402 of the sampled synthetic data generating process. Candidate causal models are run on the dataset in step 1404 to obtain estimated DAGs predicted by each method. F1 scores 1405 for each method are obtained by comparing the binary adjacency matrices of the true DAG 1402 and the estimated DAG obtained by running the method. The target label 1406 is a “one-hot” vector, with a “1” for the method with the highest F1 score, i.e., the second method in this example, giving a target label “(0, 1, 0)” for the dataset. During training, a self-attention encoder 1407 is applied to the dataset. Dataset embeddings 1408 (features of the dataset) are extracted and are provided to a classifier head 1409. The classifier head 1409 predicts a probability score for each causal method. In FIG. 14, the classifier head 1409 predicts a probability of 0.2 for the first method, a probability of 0.6 for the second method, and a probability of 0.2 for the third method. Thus, the predicted best causal method for the dataset in the training iteration shown is the second method. A cross-entropy loss is computed between the predicted probabilities 1410 and the target label 1406 for the dataset.

In some examples, the following steps are performed during training:
1. Sample synthetic data generating process (DGP)
2. Sample datasets
3. Use each method for each dataset. Score how good each method performed using the true DGP.
4. Determine best method for each dataset
5. (Optional step, reduced the need for data) Pre-train the method with self-supervised training. Predict properties of the DGP such as whether the relationships between variables are linear or not. This is only possible since synthetic and controlled DGPs have been used.
6. Train method selection model to classify which method is likely to perform the best for a given dataset.

In some examples, the following steps are performed at inference time:
Apply the selection model (as trained in step 6) to a new dataset. Use the predicted best method for the new dataset to solve the causal task.

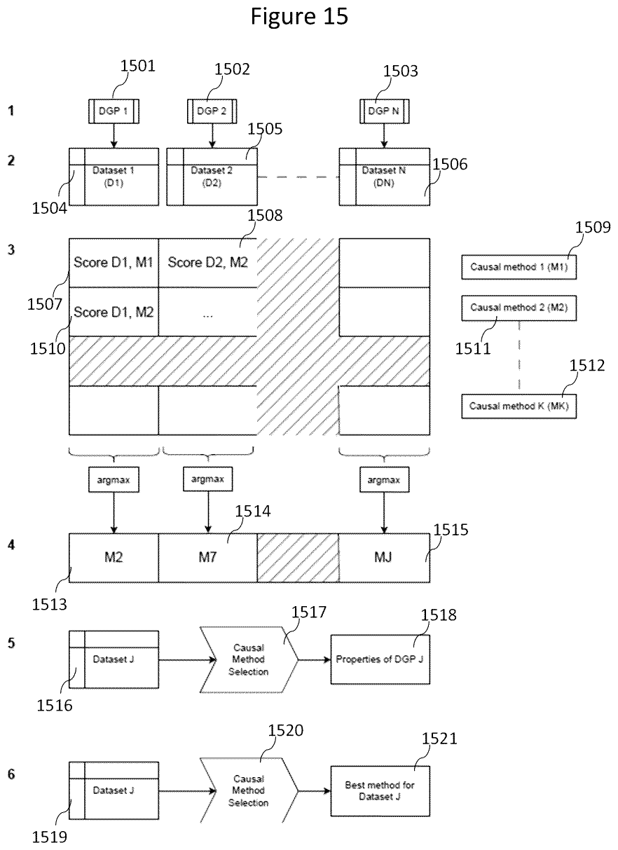

FIG. 15 shows the steps which are followed for the whole method selection process:
1-2: The DGPs (1501, 1502, 1503) are sampled with the following procedure, running on a single instance:
   a. A set of dataset specifications are generated which specify details such as the number of dataset samples, the number of variables in the dataset, the type of functional relationships between the variables and so on. A set of dataset specifications, that span the range of expected real datasets which might be encountered, is desirable.
   b. For each dataset specification
      i. For each number of datasets to create per specification
         1. Sample a random Erdös-Rényi directed acyclic graph (DAG) of the specified size
         2. Sample the number of data points required using the DAG to represent the adjacency matrix between variables and randomly selected functional relationships between them following the specification
         3. Save sampled data points and the graph
Thus datasets 1504, 1505, and 1506 are created by sampling the DGPs 1501, 1502 and 1503 respectively.
3: All methods (1509, 1511, 1512) are scored by running the following in parallel in a cluster. In this case Azure ML is used, but any other ML software can be used.
   a. For each synthetic dataset (1504, 1505, 1506)
      i. For each method (1509, 1511, 1512) in the set of methods
         1. Use the method to solve a causal task of interest, e.g. causal discovery (predicting the DAG)
         2. Score the performance of the method using the details about the DGP. For causal discovery, use the graph and evaluate the f1 score for all edges.
         In FIG. 15, reference numeral 1507 represents the score of method 1509 on dataset 1504. Reference numeral 1508 represents the score of method 1509 on dataset 1505. Reference numeral 1510 denotes the score of method 1511 on dataset 1504.
         3. Store the performance for the combination of dataset and method.
4: Collect the data from all runs and determine the best method for each dataset. The best method for a given dataset is the method with the highest score on the dataset.
In FIG. 15, the best method for dataset 1504 is method 1513, the best method for dataset 1505 is method 1514, and the best method for dataset 1506 is method 1515.
5: In an optional pre-training step, model 1517 which takes the dataset 1516 and predicts a property 1518 of the true DGP is trained. This model is trained on datasets sampled as in (1-2). This is formulated as a simple classification problem, a single GPU node is used. This step serves to significantly reduce the data needed for the following step. The implementation uses PyTorch lightning which is a transformer based model. It will be appreciated that other architectures can be used.
6: Train a model 1520 which takes a dataset 1519 and predicts which method 1521 performs the best. It is trained on the scored datasets from (1-3). This procedure is very similar to (5), also formulated as a simple classification problem, implemented in PyTorch lightning, uses a single GPU, and has the same architechture. If a model is pre-trained, these weights are loaded before training, otherwise a random initialization of the weights is done.

The best method may be selected based on the dataset type linear Gaussian, linear non-Gaussian, nonlinear).

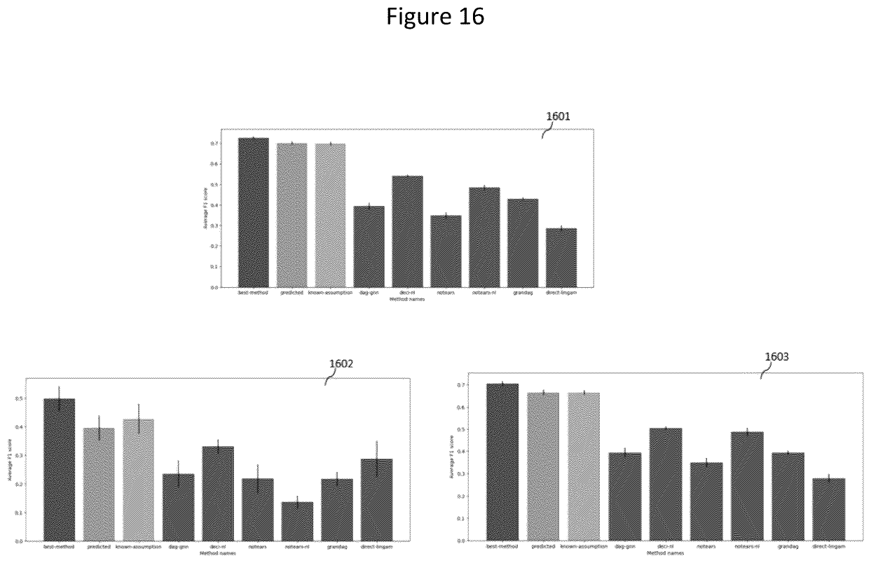

FIG. 16, plot 1601 shows the F1 scores of the six different methods and the “best method”, the “predicted” assumptions method, the “known assumption” methods on a given dataset. The “known assumption” label represents the fully supervised method; the known assumptions of the dataset are used to select a causal method for the dataset. The “predicted” label referes to the semi-supervised method; the predicted assumptions of the dataset (e.g. as predicted by a self-attention encoder) are used to select a causal method for the dataset. For the “best method” label, dataset assumptions (e.g. as predicted by a self-attention encoder) are fed to a trained classification head which predicts the best causal method.

FIG. 16, plots 1602 and 1603 show the F1 scores of the six different methods and the “best method”, the “predicted” assumptions method, the “known assumption” methods on the same dataset as in plot 1601, but where the method is evaluated on larger graph sizes of 40 and 50 nodes respectively. The similar relationships, between the F1 scores from the different methods, in plots 1601, 1602 and 1603 shows that the model generalizes to a different graph distribution.

This technology can be applied to novel scenarios whenever causal effects needs to be identified. For example, in the manufacturing industry, it is desirable to quantitatively identify the impact from different factors that affect product quality, production efficiency, and machinery performance in manufacturing processes. Given a quantitative causal model and certain amount of trial data, the present method would allow better and faster understanding of how well this model can predict certain the causal relationships between these factors, companies can optimize their processes, reduce waste, and improve overall efficiency. In the aerospace industry, root cause analysis is crucial to identify the underlying causes of faults and malfunctions in aircraft systems. The discussed method can help evaluating which root causal analysis method is the most efficient for guiding targeted maintenance and repair actions, by analyzing experimental data from sensors, maintenance records, and incident reports, causal inference methods. In genome-wide association studies (GWAS), it is crucial to test the hypotheses that associate genetic variants and a trait or disease. The disclosed method would accelerate the process of validating those assumptions via experimental data.

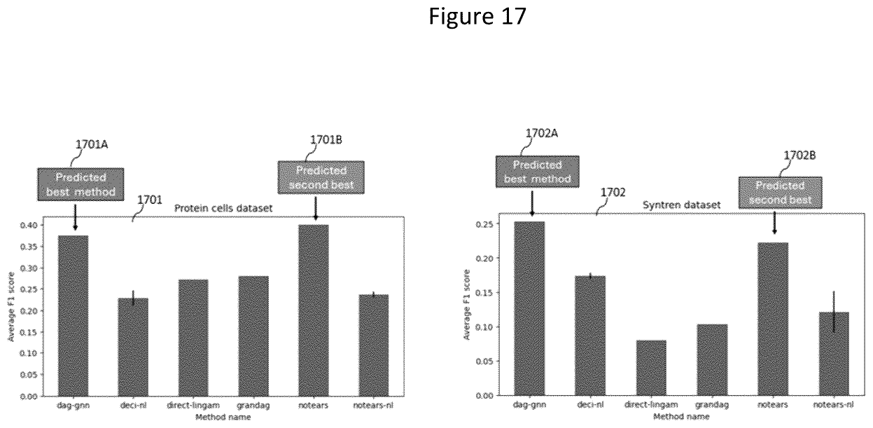

FIG. 17, plot 1701 shows the average F1 scores for the six methods in Table 1 evaluated on a real-world protein cells dataset with an 11-node graph and 800 samples. The method “dag-gnn” achieves an average F1 score of about 0.375 and the “notears” method achieves an average F1 score of about 0.4. The zero-shot causal method predicts “dag-gnn” as the best method 1701A and “notears” as the second best method 1701B. Thus, despite a synthetic training set, the method selection is effective.

FIG. 17, plot 1702 shows the average F1 scores for the six methods in Table 1 evaluated on a semi-synthetic Syntren dataset with a 20-node graph and 400 samples. The method “dag-gnn” achieves an average F1 score of about 0.25 and the “notears” method achieves an average F1 score of about 0.21. The zero-shot causal method predicts “dag-gnn” as the best method 1702A and “notears” as the second best method 1702B.

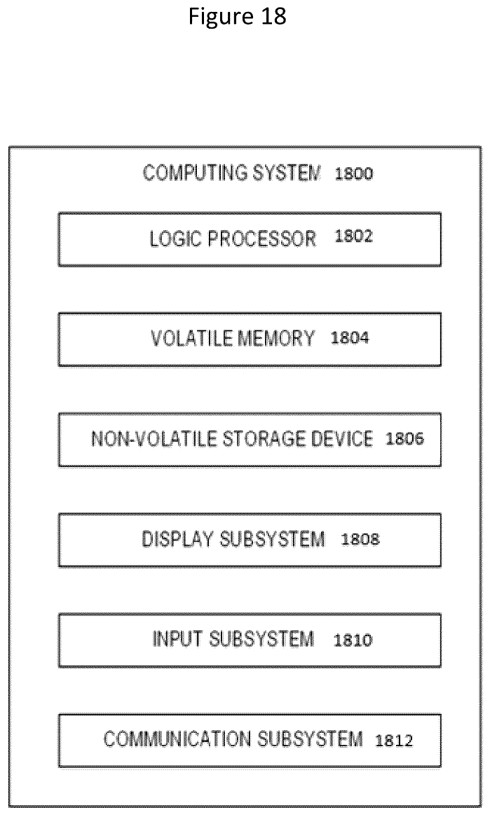

FIG. 18 schematically shows a non-limiting example of a computing system 1800, such as a computing device or system of connected computing devices, that can enact one or more of the methods or processes described above, including the filtering of data and implementation of the structured knowledge base described above. Computing system 1800 is shown in simplified form. Computing system 1800 includes a logic processor 1802, volatile memory 1804, and a non-volatile storage device 1806. Computing system 1800 may optionally include a display subsystem 1808, input subsystem 1810, communication subsystem 1812, and/or other components not shown in FIG. 18. Logic processor 1802 comprises one or more physical (hardware) processors configured to carry out processing operations. For example, the logic processor 1802 may be configured to execute instructions that are part of one or more applications, programs, routines, libraries, objects, components, data structures, or other logical constructs. The logic processor 1802 may include one or more hardware processors configured to execute software instructions based on an instruction set architecture, such as a central processing unit (CPU), graphical processing unit (GPU) or other form of accelerator processor. Additionally or alternatively, the logic processor 1802 may include a hardware processor(s)) in the form of a logic circuit or firmware device configured to execute hardware-implemented logic (programmable or non-programmable) or firmware instructions. Processor(s) of the logic processor 1802 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 1802 may be virtualized and executed by remotely accessible, networked computing devices configured in a cloud-computing configuration. In such a case, these virtualized aspects are run on different physical logic processors of various different machines. Non-volatile storage device 1806 includes one or more physical devices configured to hold instructions executable by the logic processor 1802 to implement the methods and processes described herein. When such methods and processes are implemented, the state of non-volatile storage device 1806 may be transformed—e.g., to hold different data. Non-volatile storage device 1806 may include physical devices that are removable and/or built-in. Non-volatile storage device 1806 may include optical memory (e g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 1806 may include nonvolatile, dynamic, static, read/write, read-only, sequential-access, location-addressable, file-addressable, and/or content-addressable devices. Volatile memory 1804 may include one or more physical devices that include random access memory. Volatile memory 1804 is typically utilized by logic processor 1802 to temporarily store information during processing of software instructions. Aspects of logic processor 1802, volatile memory 1804, and non-volatile storage device 1806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. The terms “module,” “program,” and “engine” may be used to describe an aspect of computing system 1800 typically implemented in software by a processor to perform a particular function using portions of volatile memory, which function involves transformative processing that specially configures the processor to perform the function. Thus, a module, program, or engine may be instantiated via logic processor 1802 executing instructions held by non-volatile storage device 1806, using portions of volatile memory 1804. Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. When included, display subsystem 1808 may be used to present a visual representation of data held by non-volatile storage device 1806. The visual representation may take the form of a graphical user interface (GUI). As the herein-described methods and processes change the data held by the non-volatile storage device, and thus transform the state of the non-volatile storage device, the state of display subsystem 1808 may likewise be transformed to visually represent changes in the underlying data. Display subsystem 1808 may include one or more display devices utilizing virtually any type of technology. Such display devices may be combined with logic processor 1802, volatile memory 1804, and/or non-volatile storage device 1806 in a shared enclosure, or such display devices may be peripheral display devices. When included, input subsystem 1810 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 1812 may be configured to communicatively couple various computing devices described herein with each other, and with other devices. Communication subsystem 1812 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1800 to send and/or receive messages to and/or from other devices via a network such as the internet. The term computer readable media as used herein may include computer storage media. Computer storage media may include volatile and non-volatile, removable and nonremovable media (e.g., volatile memory 1804 or non-volatile storage 1806) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 1800 or a component device thereof). Computer storage media does not include a carrier wave or other propagated or modulated data signal. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

A first aspect herein provides a computer-implemented method, comprising: generating a pre-training synthetic dataset using a data synthesis process; determining a predicted property of the pre-training synthetic dataset using a property prediction model; pre-training the property prediction model based on: the pre-training synthetic dataset, and a pre-training loss that quantifies error between a known property of the pre-training synthetic dataset and the predicted property, resulting in a trained property prediction model; extracting a pre-trained feature extractor from the pre-trained property prediction model; generating a fine-tuning synthetic dataset and a validation synthetic groundtruth associated with the fine-tuning synthetic dataset; executing a first candidate algorithm with the fine-tuning synthetic dataset as input; comparing the validation synthetic groundtruth with a first output of the first candidate algorithm as executed on the fine-tuning synthetic dataset, resulting in a first performance score; executing a second candidate algorithm with the fine-tuning synthetic dataset as input; comparing the validation synthetic groundtruth with a second output of the second candidate algorithm as executed on the fine-tuning synthetic dataset, resulting in a second performance score; associating model selection groundtruth with the fine-tuning synthetic dataset based on the first performance score and the second performance score, the model selection groundtruth indicating relative performance of the first candidate algorithm and the second candidate algorithm on the fine-tuning synthetic dataset; extracting synthetic features from the fine-tuning synthetic dataset using the pre-trained feature extractor; and training an algorithm selection model based on the synthetic features extracted from the fine-tuning synthetic dataset and the model selection ground truth associated with the fine-tuning synthetic dataset, resulting in a trained algorithm selection model configured to predict relative performance of the first candidate algorithm and the second candidate algorithm based on features extracted from a real dataset by the pre-trained feature extractor.

In embodiments, the method may comprise: receiving a first real dataset; extracting first real features from the first real dataset using the pre-trained feature extractor; selecting, using the trained algorithm selector applied to the first real features, the first candidate algorithm; executing the first candidate algorithm with the first real dataset as input.

The method may comprise: performing a first action on a first physical or logical system based on a first result of the first candidate algorithm as executed on the first real dataset.

The method may comprise: receiving a second real dataset; extracting second real features from the second real dataset using the pre-trained feature extractor; selecting, using the trained algorithm selector applied to the second real features, the second candidate algorithm; executing the second candidate algorithm with the second real dataset as input.

The method may comprise: performing a second action on a second physical or logical system based on a second result of the second candidate algorithm as executed on the second real dataset.

The algorithm selection model may be trained based on a selection training loss that quantifies error between the second ground truth and a selection output of the algorithm selection model.

The known property may comprise an assumption used to generate the synthetic dataset.

The model selection ground truth may indicate a best performing of the first candidate algorithm and the second candidate algorithm, wherein the trained algorithm selection may output a ranking of the first candidate algorithm and the second candidate algorithm on the real dataset.

The first candidate algorithm may be a first computer vision algorithm and the second candidate algorithm may be a second computer vision algorithm, the pre-training synthetic dataset and the fine-tuning synthetic dataset may each comprise synthetic image data; or the first candidate algorithm may be a first cybersecurity algorithm and the second candidate algorithm may be a second cybersecurity algorithm, the pre-training synthetic dataset and the fine-tuning synthetic dataset may each comprise synthetic cybersecurity data; or the first candidate algorithm may be a first audio processing algorithm and the second candidate algorithm may be a second audio processing algorithm, the pre-training synthetic dataset and the fine-tuning synthetic dataset each comprising synthetic audio data; or the first candidate algorithm may be a first manufacturing or engineering algorithm and the second candidate algorithm may be a second manufacturing or engineering algorithm, the pre-training synthetic dataset and the fine-tuning synthetic dataset may each comprise synthetic manufacturing or engineering data.

A second aspect herein provides a computer system comprising: a memory configured to store computer-readable instructions; and a hardware processor coupled to the memory, wherein the computer-readable instructions are configured to cause the hardware processor to: receive a synthetic dataset and validation groundtruth associated with the synthetic dataset; execute a first candidate causal algorithm with the synthetic dataset as input; compare the validation groundtruth with a first output of the first candidate causal algorithm as executed on the synthetic dataset, resulting in a first performance score; execute a second candidate causal algorithm with the synthetic dataset as input; compare the second groundtruth with a second output of the second candidate causal algorithm as executed on the synthetic dataset, resulting in a second performance score; associate model selection groundtruth with the synthetic dataset based on the first performance score and the second performance score, the model selection groundtruth indicating relative performance of the first candidate causal algorithm and the second candidate causal algorithm on the synthetic dataset; and train an algorithm selection model based on the synthetic dataset and the model selection ground truth associated with the synthetic dataset, resulting in a trained algorithm selection model configured to predict relative performance of the first candidate causal algorithm and the second candidate causal algorithm based on a further dataset received as input.

In embodiments, the system may comprise: receiving a first real dataset; selecting, using the trained algorithm selector applied to the first real dataset, the first candidate causal algorithm; executing the first candidate causal algorithm with the first real dataset as input.

The system may comprise: performing a first action on a first physical system based on a first result of the first candidate causal algorithm as executed on the first real dataset.

The first physical system may comprise a machine or computer system and the first result may comprise an estimated treatment effect for the first action performed on the machine or the computer system.

The treatment effect may pertain to product quality, production efficiency, machinery performance, or usage of memory or processing resources.

The synthetic dataset may comprise synthetic medical data, wherein executing the first candidate causal algorithm with the first real dataset as input may result in a predicted therapeutic effect.

The system may comprise: receiving a second real dataset; selecting, using the trained algorithm selector applied to the second real dataset, the second candidate causal algorithm; executing the second candidate causal algorithm with the second real dataset as input.

The system may comprise: performing a second action on a second physical system based on a second result of the second candidate causal algorithm as executed on the second real dataset.

The algorithm selection model may be trained based on a selection training loss that quantifies error between the second ground truth and a selection output of the algorithm selection model.

The first and second candidate causal algorithms may be configured to identify causal relationships in data.

A third aspect herein provides computer-readable storage media embodying computer readable instructions, the computer-readable instructions configured upon execution on a hardware processor to cause the hardware processor to: receive a synthetic dataset and validation groundtruth associate with the synthetic dataset; execute a first candidate causal algorithm with the synthetic dataset as input; compare the validation groundtruth with a first output of the first candidate causal algorithm as executed on the synthetic dataset, resulting in a first performance score; execute a second candidate causal algorithm with the synthetic dataset as input; compare the second groundtruth with a second output of the second candidate causal algorithm as executed on the synthetic dataset, resulting in a second performance score; associate model selection groundtruth with the synthetic dataset based on the first performance score and the second performance score, the model selection groundtruth indicating relative performance of the first candidate causal algorithm and the second candidate causal algorithm on the synthetic dataset; and train an algorithm selection model based on the synthetic dataset and the model selection ground truth associated with the synthetic dataset, resulting in a trained algorithm selection model configured to predict relative performance of the first candidate causal algorithm and the second candidate causal algorithm based on a further dataset received as input.

It will be appreciated that the above embodiments have been disclosed by way of example only. Other variants or use cases may become apparent to a person skilled in the art once given the disclosure herein. The scope of the present disclosure is not limited by the above-described embodiments, but only by the accompanying claims.

1. A computer-implemented method, comprising:
generating a pre-training synthetic dataset using a data synthesis process;
determining a predicted property of the pre-training synthetic dataset using a property prediction model;
pre-training the property prediction model based on: the pre-training synthetic dataset, and a pre-training loss that quantifies error between a known property of the pre-training synthetic dataset and the predicted property, resulting in a trained property prediction model;
extracting a pre-trained feature extractor from the pre-trained property prediction model;
generating a fine-tuning synthetic dataset and a validation synthetic groundtruth associated with the fine-tuning synthetic dataset;
executing a first candidate algorithm with the fine-tuning synthetic dataset as input;
comparing the validation synthetic groundtruth with a first output of the first candidate algorithm as executed on the fine-tuning synthetic dataset, resulting in a first performance score;
executing a second candidate algorithm with the fine-tuning synthetic dataset as input;
comparing the validation synthetic groundtruth with a second output of the second candidate algorithm as executed on the fine-tuning synthetic dataset, resulting in a second performance score;
associating model selection groundtruth with the fine-tuning synthetic dataset based on the first performance score and the second performance score, the model selection groundtruth indicating relative performance of the first candidate algorithm and the second candidate algorithm on the fine-tuning synthetic dataset;
extracting synthetic features from the fine-tuning synthetic dataset using the pre-trained feature extractor; and
training an algorithm selection model based on the synthetic features extracted from the fine-tuning synthetic dataset and the model selection ground truth associated with the fine-tuning synthetic dataset, resulting in a trained algorithm selection model configured to predict relative performance of the first candidate algorithm and the second candidate algorithm based on features extracted from a real dataset by the pre-trained feature extractor.

2. The method of claim 1, comprising:
receiving a first real dataset;
extracting first real features from the first real dataset using the pre-trained feature extractor;
selecting, using the trained algorithm selector applied to the first real features, the first candidate algorithm;
executing the first candidate algorithm with the first real dataset as input.

3. The method of claim 2, comprising:
performing a first action on a first physical or logical system based on a first result of the first candidate algorithm as executed on the first real dataset.

4. The method of claim 2, comprising:
receiving a second real dataset;
extracting second real features from the second real dataset using the pre-trained feature extractor;
selecting, using the trained algorithm selector applied to the second real features, the second candidate algorithm;
executing the second candidate algorithm with the second real dataset as input.

5. The method of claim 4, comprising:
performing a second action on a second physical or logical system based on a second result of the second candidate algorithm as executed on the second real dataset.

6. The method claim 1, wherein the algorithm selection model is trained based on a selection training loss that quantifies error between the second ground truth and a selection output of the algorithm selection model.

7. The method of claim 1, wherein the known property comprises an assumption used to generate the synthetic dataset.

8. The method of claim 1, wherein the model selection ground truth indicates a best performing of the first candidate algorithm and the second candidate algorithm, wherein the trained algorithm selection outputs a ranking of the first candidate algorithm and the second candidate algorithm on the real dataset.

9. The method of claim 1, wherein:
the first candidate algorithm is a first computer vision algorithm and the second candidate algorithm is a second computer vision algorithm, the pre-training synthetic dataset and the fine-tuning synthetic dataset each comprising synthetic image data; or
the first candidate algorithm is a first cybersecurity algorithm and the second candidate algorithm is a second cybersecurity algorithm, the pre-training synthetic dataset and the fine-tuning synthetic dataset each comprising synthetic cybersecurity data; or
the first candidate algorithm is a first audio processing algorithm and the second candidate algorithm is a second audio processing algorithm, the pre-training synthetic dataset and the fine-tuning synthetic dataset each comprising synthetic audio data; or
the first candidate algorithm is a first manufacturing or engineering algorithm and the second candidate algorithm is a second manufacturing or engineering algorithm, the pre-training synthetic dataset and the fine-tuning synthetic dataset each comprising synthetic manufacturing or engineering data.

10. A computer system comprising:
a memory configured to store computer-readable instructions; and
a hardware processor coupled to the memory, wherein the computer-readable instructions are configured to cause the hardware processor to: receive a synthetic dataset and validation groundtruth associated with the synthetic dataset;
execute a first candidate causal algorithm with the synthetic dataset as input;
compare the validation groundtruth with a first output of the first candidate causal algorithm as executed on the synthetic dataset, resulting in a first performance score;
execute a second candidate causal algorithm with the synthetic dataset as input;
compare the second groundtruth with a second output of the second candidate causal algorithm as executed on the synthetic dataset, resulting in a second performance score;
associate model selection groundtruth with the synthetic dataset based on the first performance score and the second performance score, the model selection groundtruth indicating relative performance of the first candidate causal algorithm and the second candidate causal algorithm on the synthetic dataset; and
train an algorithm selection model based on the synthetic dataset and the model selection ground truth associated with the synthetic dataset, resulting in a trained algorithm selection model configured to predict relative performance of the first candidate causal algorithm and the second candidate causal algorithm based on a further dataset received as input.

11. The system of claim 10, comprising:
receiving a first real dataset;
selecting, using the trained algorithm selector applied to the first real dataset, the first candidate causal algorithm;
executing the first candidate causal algorithm with the first real dataset as input.

12. The system of claim 11, comprising:
performing a first action on a first physical system based on a first result of the first candidate causal algorithm as executed on the first real dataset.

13. The system of claim 12, comprising:
receiving a second real dataset;
selecting, using the trained algorithm selector applied to the second real dataset, the second candidate causal algorithm;
executing the second candidate causal algorithm with the second real dataset as input.

14. The system of claim 12, wherein the first physical system comprises a machine or computer system and the first result comprises an estimated treatment effect for the first action performed on the machine or the computer system.

15. The system of claim 14, wherein the treatment effect pertains to product quality, production efficiency, machinery performance, or usage of memory or processing resources.

16. The system of claim 15, wherein the synthetic dataset comprises synthetic medical data, wherein executing the first candidate causal algorithm with the first real dataset as input results in a predicted therapeutic effect.

17. The system of claim 16, comprising:
performing a second action on a second physical system based on a second result of the second candidate causal algorithm as executed on the second real dataset.

18. The system of claim 10, wherein the algorithm selection model is trained based on a selection training loss that quantifies error between the second ground truth and a selection output of the algorithm selection model.

19. The system if claim 10, wherein the first and second candidate causal algorithms are configured to identify causal relationships in data.

20. Computer-readable storage media embodying computer readable instructions, the computer-readable instructions configured upon execution on a hardware processor to cause the hardware processor to:
receive a synthetic dataset and validation groundtruth associate with the synthetic dataset;
execute a first candidate causal algorithm with the synthetic dataset as input;
compare the validation groundtruth with a first output of the first candidate causal algorithm as executed on the synthetic dataset, resulting in a first performance score;
execute a second candidate causal algorithm with the synthetic dataset as input;
compare the second groundtruth with a second output of the second candidate causal algorithm as executed on the synthetic dataset, resulting in a second performance score;
associate model selection groundtruth with the synthetic dataset based on the first performance score and the second performance score, the model selection groundtruth indicating relative performance of the first candidate causal algorithm and the second candidate causal algorithm on the synthetic dataset; and
train an algorithm selection model based on the synthetic dataset and the model selection ground truth associated with the synthetic dataset, resulting in a trained algorithm selection model configured to predict relative performance of the first candidate causal algorithm and the second candidate causal algorithm based on a further dataset received as input.
